(19) United States
(12) Patent Application Publication
(10) Pub. No.: US 2004/0033588 A1
(43) Pub. Date: Feb. 19, 2004

(54) Mixing apparatus for biochips

(76) Inventors: Yo-Hsin Su, Kaohsiung Hsien (TW); Hsi-Lien Lu, Kaohsiung (TW); Hsun-Min Lung, Fengshan City (TW); Chung-Ho Tung, Fengshan City (TW); Ta-Chang Liu, Kaohsiung (TW); Shiming Lin, Taipei (TW); Su-Ming Hsu, Kaohsiung (TW); Chih-Kung Lee, Taipei (TW); Long-Sun Huang, Taipei (TW); Chii-Wann Lin, Taipei (TW); An-Bang Wang, Taipei (TW)

Correspondence Address: BIRCH STEWART KOLASCH & BIRCH, PO BOX 747, FALLS CHURCH, VA, 22040-0747, US

(21) Appl. No.: 10/218,624

(22) Filed: Aug. 15, 2002

(51) Int. Cl. B01L 3/00

(52) U.S. Cl. 435/283.1; 422/99; 422/101

(57) ABSTRACT

A mixing apparatus for biochips consists of a oscillation unit with controllable vibration frequency, a transmission section driven by the oscillation unit for transferring vibration of the oscillation unit, and a mixing unit connecting to and driven by the transmission section and locating at a selected distance above the biochip surface. The oscillation unit may generate vibration of a specific frequency and the vibration frequency, amplitude and duration may be controlled for effectively mixing and separating sample solution rapidly, simply and more economically.

### FIELD OF THE INVENTION

The present invention relates to a mixing apparatus for biochips and particularly to a mixing apparatus for effectively mixing the biological sample solution at solid-liquid interface of biochips.

### BACKGROUND OF THE INVENTION

With the mapping and sequencing of human genome to be completed in the near future, the next subject scientists focus is to unravel the meaning of and interactions between more than tens of thousands of genomes, and to study the function of proteins expressed. Biochips are the best tools to resolve these complex problems. The technique used in the biochips can produce highly accurate analysis at a fast speed with a small amount of test samples and reagents. And a single test can generate entire (paralleled) experimental data. Hence, biochips can be adapted for used in a wide scope of applications such as research of genomic function, new drug development, clinical examination, microbial screening, environmental control, and the likes.

The principle of the biochips is to adopt microelectronic and micromechanical technologies and immobilize biological probes (mainly originating from organic compounds, nucleic acid, protein, carbonhydrate, cells, tissues or the likes) on a substrate (may be made of glass, silicon plate, plastics, etc.) of a thumb nail size, then biological sample solution to be tested (including blood, urine, or solution that contain targets) is applied and then mixed on the chips. The targets and the corresponding biological probes on the chips have specificity and can interact with each other and generate signal alterations (including optical, piezoelectric, eletrochemical, thermal signals), or unbound interferents can be washed and separated from the bound target and then the target-probe complex labeled with fluorescent, colorimetric or radiative material can be quantitated to obtain analysis information of the testing biological samples.

Conventional mixing and separating processes are very simple. They are generally done by adding biological sample solution on the chips, incubating the chips for a period of time, then washing and separating the bound targets from other interferents with buffer solution. Such a method used above is rough. It possibly results in errors in quantitative analysis due to variations in mixing force and incubation time.

### SUMMARY OF THE INVENTION

Therefore, the principle object of the invention is to resolve aforesaid disadvantages. The invention provides a mixing apparatus for biochips which includes a piezoelectric ceramic transducer that is capable of transferring voltage oscillation to mechanical vibration. The mixing apparatus may be used in biological preparation and analysis steps (including immobilization, washing and interaction), and the construction includes an oscillation unit, a transmission section for transferring vibration of the oscillation unit, and a mixing unit connecting to and driven by the transmission section. The mixing unit includes more than one mixing rod. The oscillation unit generates vibration of a specific frequency. The vibration is transmitted through the transmission section to the mixing unit, then drives the mixing rod located at a selected distance above the biochip surface to vibrate, thereby enhancing the interactions between biological probes immobilized on the chips and specific targets in the solution. The biological testing or diagnosis can be performed rapidly, simply and more economically by means of accurate control of vibration frequency, amplitude and duration.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the invention.

FIG. 2 is a sectional view of the invention.

FIG. 3 is a schematic view of the invention in an operating condition.

FIGS. 4A, 4B are schematic views of the invention operating in a horizontal condition.

FIGS. 5A, 5B are schematic views of the invention operating in a vertical condition.

FIG. 6 is a schematic view of an overall configuration of the invention.

### DESCRIPTION OF THE PREFERRED EMBODIMENT

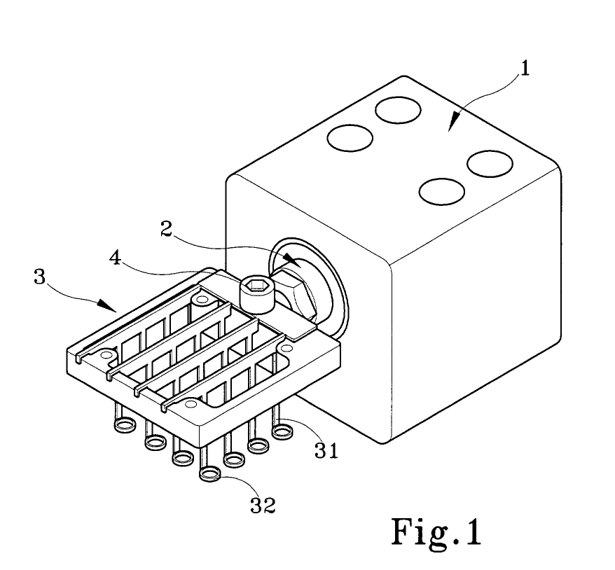

Referring to FIG. 1, the mixing apparatus of the invention mainly consists of a oscillation unit 1, a transmission section 2 driven by the oscillation unit 1 to transfer vibration of the oscillation unit 1, and a mixing unit 3 connecting to and driven by the transmission section 2. The mixing unit 3 is fastened to the transmission section 2 by a fastening element 4 located therebetween (the mixing unit 3 may also be integrally made with the transmission section 2). The mixing unit 3 includes more than one mixing rod 31. The mixing rod 31 has a free end attaching to a mixing ring 32 for increasing vibration range. The oscillation unit 1 generates vibration of a specific frequency to biological sample solution 5 to be tested. The oscillation unit 1 drives the transmission section 2 which in turn actuates the mixing unit 3. The mixing unit 3 is located at a selected distance above the biological sample solution 5 to be tested and generates vibration of a specific frequency to mix the biological sample solution 5. The biological sample solution 5 contains targets 51 which may interact with biological probes 61 on the biochips 6. And other interferents 52 which do not interact with probes 61 are separated. Therefore the biological sample solution 5 may be effectively mixed and the interactions between biological probes 61 and target 51 may be enhanced by use of the mixing apparatus for microarray biochips 6 of the invention.

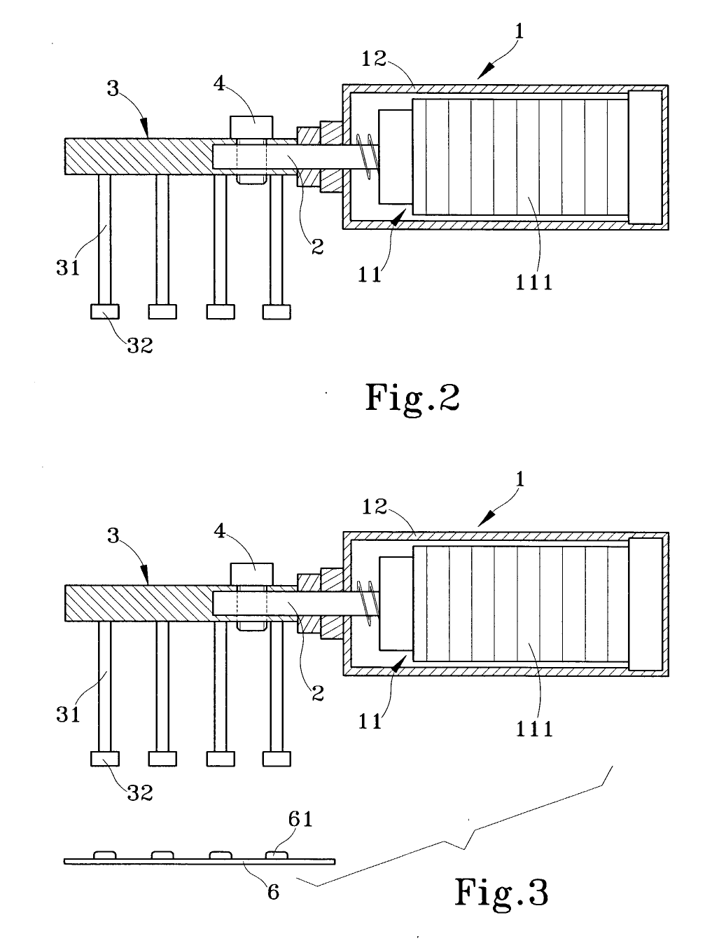

Referring to FIG. 2, the oscillation unit 1 of the invention mainly includes a piezoelectric actuator 11 which consists of a plurality of piezoelectric ceramic elements 111 stacking over one another. Each of the piezoelectric ceramic elements 111 is made through a poling process and equips desired polarity, and can transfer phase transformation resulting from voltage oscillation to mechanical vibration. In addition, the exterior of the piezoelectric actuator 11 is encased by a shell 12 for shielding purpose. The piezoelectric actuator 11 has one end connecting to the transmission section 2 which runs through the shell 12. The transmission section 2 then connects o the mixing unit 3.

When in use, prepare the biological sample solution 5 and set up the corresponding biochip 6. The biological sample solution 5 contains targets 51 to be tested and interferents 52. In addition, the biochip 6 is a substrate with biological probes 61 anchoring thereon. The biological probes 61 can interact with the targets 51 to proceed with affinity binding or catalytic reaction. Then the biochips 6 are placed below the mixing unit 3 of the invention, and the mixing unit 3 is lowered until being positioned above the chips for a specific distance. Then the invention is activated to vibrate at a specific frequency to mix the biological sample solution 5 for molecular interaction, washing and separation.

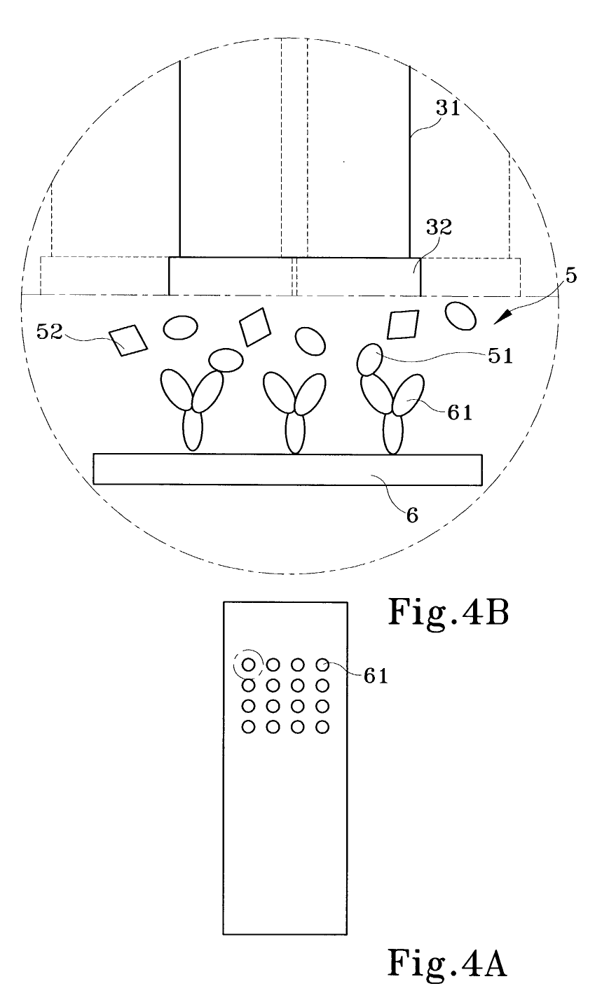

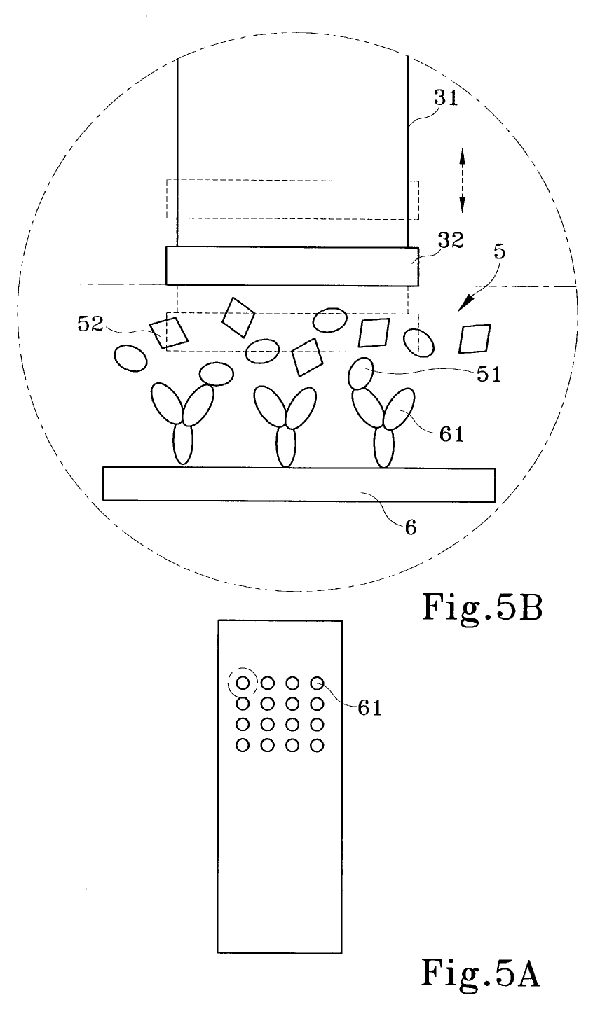

Refer to FIGS. 3, 4A, 4B, 5A and 5B for the invention in an operating condition, and operating in horizontal and vertical conditions. As shown in the drawings, the microarray biochips 6 with the biological sample solution 5 added thereon are located below the mixing unit 3, furthermore the biological probes 61 on the microarray biochips 6 corresponding to the mixing rod 31. When the oscillation unit 1 is activated to mix the biological sample solution 5 at a specific frequency, the mixing unit 3 is driven by the transmission section 2, and the mixing ring 32 located below the mixing unit 3 starts to generate vibration at the solid-liquid interface between the biological probes 61 of the biochips 6 and the biological sample solution 5. The direction of vibration may be parallel or normal to the biochip surface 5. The vibration generated during the mixing operation can accelerate the diffusion of the reaction pair (the targets 51 and biological probes 61) to a distance to proceed with orientation appropriate for interaction, followed by complexation. Therefore, the vibration can achieve effective mixing and separation of the biological sample solution 5.

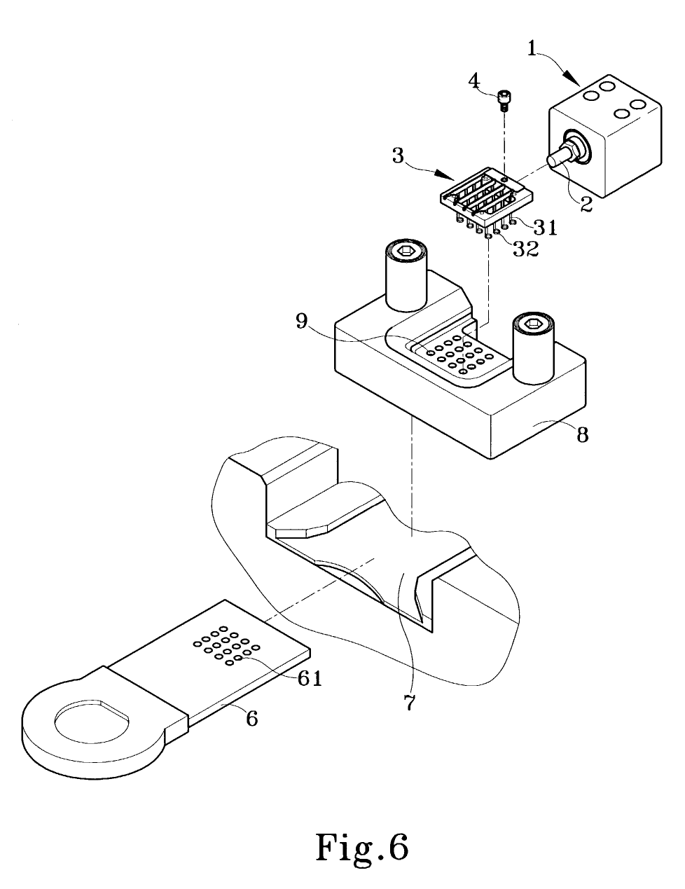

Refer to FIG. 6 for the overall configuration of the invention. The mixing apparatus for microarray biochips 6 is located on an analyzer which has a chip slot 7 to hold the microarray biochips 6. There is an anchoring dock 8 located between the invention and the chip slot 7. The anchoring dock 8 has apertures 9 to allow the mixing rods 31 to pass through. The invention and the anchoring dock 8 enable users to make adjustment upward or downward to move the biochips 6 in the chip slot 7, and to facilitate users to add the biological sample solution 5 individually or integrally onto the reaction spot array of the biochip 6.

What is claimed is:

1. A mixing apparatus for bio chips, comprising:
a oscillation unit for generating vibration and controlling vibration frequency;
a transmission section driven by the oscillation unit to transfer vibration of the oscillation unit; and
a mixing unit fastening to the transmission section and locating at a selected distance above the biochips;
wherein the oscillation unit generates vibration of a specific frequency and drives the transmission section and the mixing unit to mix the biological sample solution at the specific frequency and to accelerate the diffusion of the target-probe reaction pair to a distance to proceed with orientation appropriate for interaction followed by complexation.

2. The mixing apparatus for biochips of claim 1, wherein the vibration frequency generated by the oscillation unit can be adjusted corresponding to the biological sample solution which includes organic compounds, nucleic acid, protein, or carbonhydrate, or other biological molecules.

3. The mixing apparatus for biochips of claim 1, wherein the mixing unit is vibrated and the direction of vibration is normal to the biochip surface.

4. The mixing apparatus for biochips of claim 1, wherein the mixing unit is vibrated and the direction of vibration is parallel to the biochip surface.

5. The mixing apparatus for biochips of claim 1, wherein the oscillation unit includes a piezoelectric actuator encasing in a shielding shell.

6. The mixing apparatus for biochips of claim 5, wherein the piezoelectric actuator consists of a plurality of piezoelectric ceramic elements stacking one upon another.

7. The mixing apparatus for biochips of claim 1, wherein the mixing unit connects to at least one mixing rod.

8. The mixing apparatus for biochips of claim 7, wherein the mixing rod has a bottom end connecting to a mixing ring normal to the mixing rod for increasing mixing range.

9. The mixing apparatus for biochips of claim 1, wherein the biochips have at least one reaction spot on which the biological probes are immobilized for the interactions with the targets.
